(19) United States
(12) Patent Application Publication
(10) Pub. No.: US 2012/0055771 A1
(43) Pub. Date: Mar. 8, 2012

(54) BACKLIGHT KEYBOARD MODULE

(76) Inventor: Chin-Yi LIN, Taipei Hsien (TW)

(21) Appl. No.: 12/876,808

(22) Filed: Sep. 7, 2010

(51) Int. Cl. H01H 9/00

(52) U.S. Cl. 200/314

(57) ABSTRACT

A backlight keyboard module includes a keyboard portion and a light emitting portion located on the keyboard portion. The keyboard portion includes a baseboard, a keycap movable up and down relative to the baseboard, and a circuit board depressed by the up and down movements of the keycap to output signals. The light emitting portion has a shading plate located beneath the keycap and a light emitting element to provide light. The shading plate has an opening corresponding to the keycap to allow light of the light emitting element to pass through and project to the keycap. Thus the keyboard only illuminates light on the keycap location in a non-uniform manner to highlight the location of the keycap to improve keystroke accuracy.

### FIELD OF THE INVENTION

The present invention relates to a backlight keyboard module and particularly to a backlight keyboard module for computers that emits light to identify keycap location.

### BACKGROUND OF THE INVENTION

In the technology information times today, computers become indispensable in people's daily life. Almost every line of business has to rely on computers to aid operation, either desktop computers or notebook computers. The application scope and occasion are very extensive, and they could be used in any environment. However, in a low illumination or dark environment, insufficient light could cause inaccurate keystroke and result in erroneous signal output. To solve such a problem many types of illuminated keyboards have been developed.

For instance, U.S. Pat. Nos. 6,179,432, 6,199,996, 6,284,988 and 6,554,442 respectively have disclosed an illuminated keyboard which mainly has a light emitting sheet held in the keyboard to illuminate keycaps to facilitate operation of the keyboard in an insufficient light or dark environment.

However, the aforesaid techniques mostly have an elastic element and a driven mechanism interposed between the light emitting sheet and keycaps. The keycaps, elastic element and driven mechanism are mostly made of light permeable material (some of the techniques have the keycaps made of opaque material but with character portions of the keycaps made of the light permeable material). When the entire light emitting sheet emits light, the keyboard is evenly illuminated as a backlight. As the illuminated keyboard generally is used in an insufficient light or dark environment, such as on an airplane, vehicle or the like, the entire evenly illuminated keyboard has too strong illumination that could affect people nearby. Moreover, in the lower illumination environment, user's visual capability for the keyboard is lower. If the entire keyboard is illuminated evenly, user even is difficult to identify the character notation of each keycap. Even if the character notation is made of opaque material, or the keycap is made of opaque material while the character notation made of light permeable material, light emitted from the gaps of neighboring keycaps creates interference effect that makes identification difficult. To users who cannot well memorize the keycap character notations, erroneous keystroke frequently happens and results in mistaken command signal output.

### SUMMARY OF THE INVENTION

The primary object of the present invention is to solve the aforesaid disadvantage by providing illumination merely on keycaps of a keyboard to differentiate keycap locations.

To achieve the foregoing object, the present invention provides a backlight keyboard module that includes a keyboard portion and a light emitting portion located on the keyboard portion. The keyboard portion includes a baseboard, a keycap moved up and down relative to the baseboard and a circuit board to output a signal by up and down movements of the depressible keycap. The light emitting portion has a shading plate located beneath the keycap and a light emitting element to provide light. The shading plate has an opening corresponding to the keycap to allow the light of the light emitting element to pass through and transmit to the keycap.

Compared with the conventional techniques, the keyboard of the invention only emits light on the keycap location rather than illuminates in a uniform manner. Hence keycap location can be highlighted to improve keystroke accuracy.

The foregoing, as well as additional objects, features and advantages of the invention will be more readily apparent from the following detailed description, which proceeds with reference to the accompanying embodiment and drawings. The embodiment serves merely for illustrative purpose and is not the limitation of the invention.

### BRIEF DESCRIPTION OF THE DRAWINGS

FIG. 1 is an exploded view of the structure of the invention.

FIG. 2 is another exploded view of the structure of the invention.

FIG. 3 is yet another exploded view of the structure of the invention.

FIG. 4 is a sectional view of a first embodiment of the invention.

FIG. 5 is a sectional view of a second embodiment of the invention.

FIG. 6 is a sectional view of a third embodiment of the invention.

### DETAILED DESCRIPTION OF THE PREFERRED EMBODIMENTS

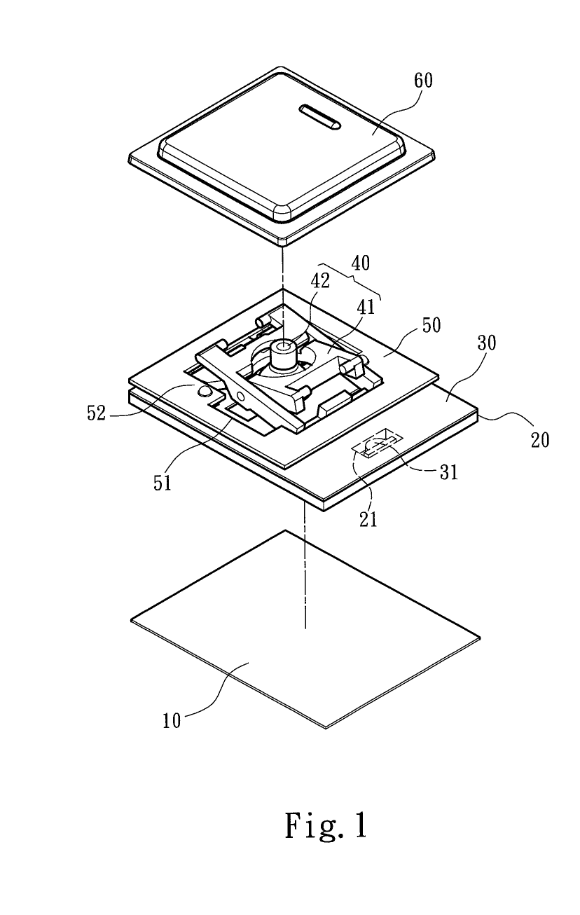

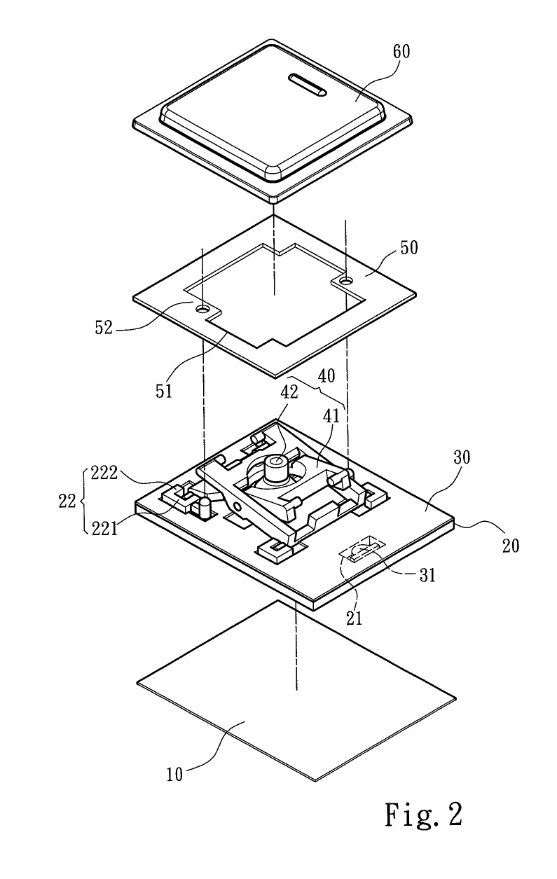

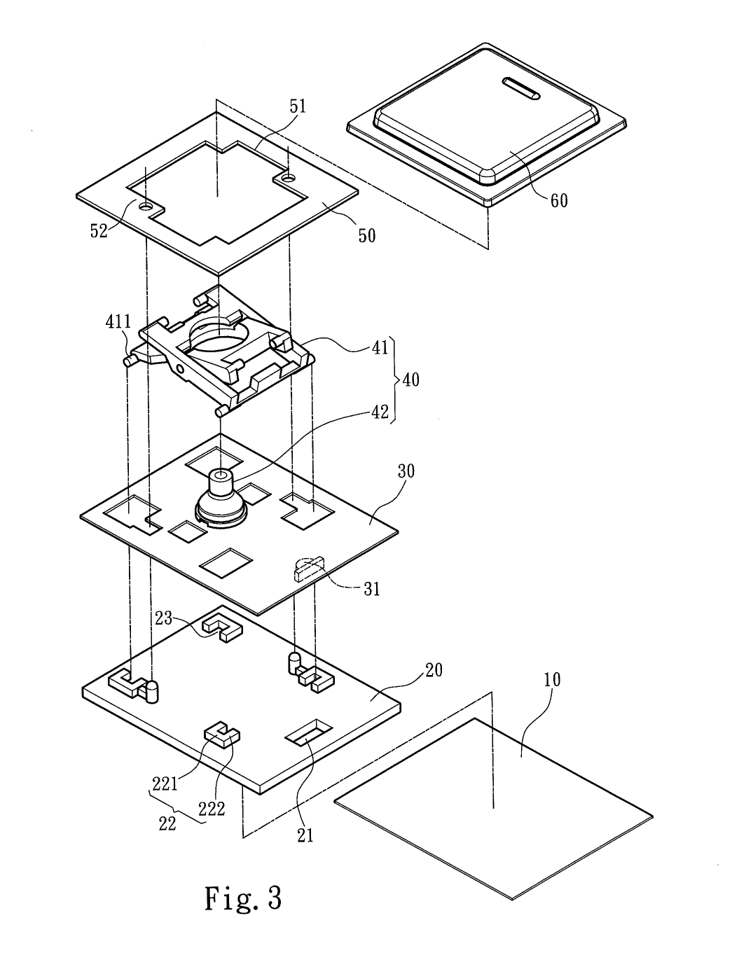

Please refer to FIGS. 1, 2 and 3, the present invention aims to provide a backlight keyboard module which mainly includes a keyboard portion and a light emitting portion located on the keyboard portion. The keyboard portion includes a baseboard 20, a keycap 60 located on the baseboard 20, a circuit board 30 located between the baseboard 20 and the keycap 60, and a bottom board 10 to hold the baseboard 20 and circuit board 30. The baseboard 20 and keycap 60 further are interposed by a driven mechanism 40 which includes a coupling member 41 bridging the baseboard 20 and keycap 60 and an elastic member 42 located on the circuit board 30 to support the keycap 60. The keycap 60 is depressible up and down relative to the baseboard 20 through the driven mechanism 40. As the keycap 60 is depressible up and down, the elastic member 42 compresses the circuit board 30 to output a signal.

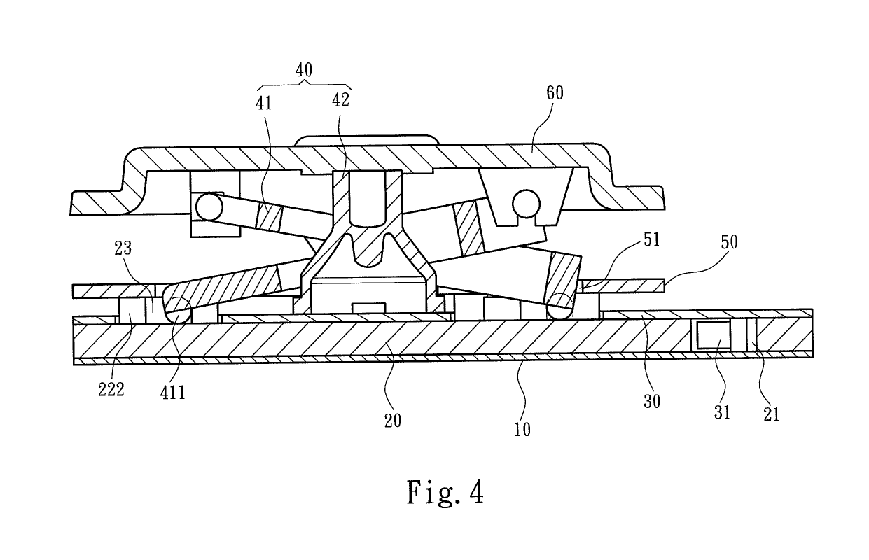

The light emitting portion of the invention includes a shading plate 50 located below the keycap 60 and a light emitting element 31 to provide light. The shading plate 50 has an opening 51 corresponding to the keycap 60 and run through by the driven mechanism 40 as shown in FIG. 4. The light emitting element 31 is a light emitting diode (LED) located below the circuit board 30 to get electric power from the circuit board 30 to emit light. The baseboard 20 has a holding cavity 21 to hold the light emitting element 31. Light emitted from the light emitting element 31 is transmitted between the shading plate 50 and bottom board 10, and passes through the opening 51 to project to the keycap 60. Thus forms the main structure of the invention. Therefore, the keyboard only illuminates light on the keycap 60 to help differentiating the location of the keycap 60.

In addition, in one embodiment of the invention, the baseboard 20 has an anchor portion 22 to hold the coupling member 41. The anchor portion 22 has two horizontal detent portions 222 and a detent wall 221 vertically bridging two ends of the two horizontal detent portions 222 to form a U shape with a holding space 23 formed therebetween. The coupling member 41 has a retaining portion 411 held in the holding space 23. The shading plate 50 has a vertical detent portion 52 to cover the holding space 23. Hence the shading plate 50, in addition to enhancing the illumination of the keycap 60 to highlight the location thereof, also can confine the horizontal and vertical movements of the retaining portion 411 to achieve positioning effect through the two horizontal detent portions 222 and vertical detent portion 52 while the coupling member 41 driven by the up and down movements of the keycap 60. For assembly of the keyboard, the baseboard 20, circuit board 30, driven mechanism 40, shading plate 50 and keycap 60 are sequentially mounted in an overlapped manner without complicated assembly tasks, thus assembly processes can be simplified.

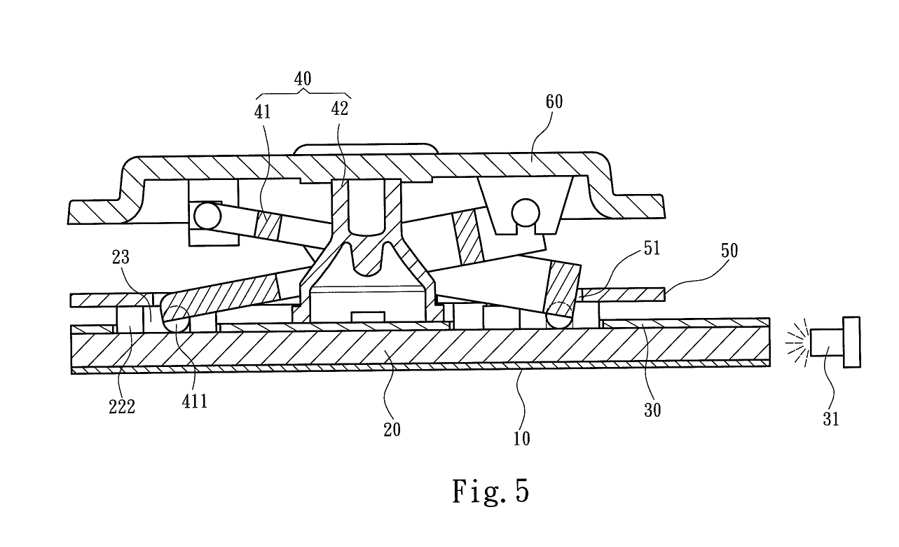

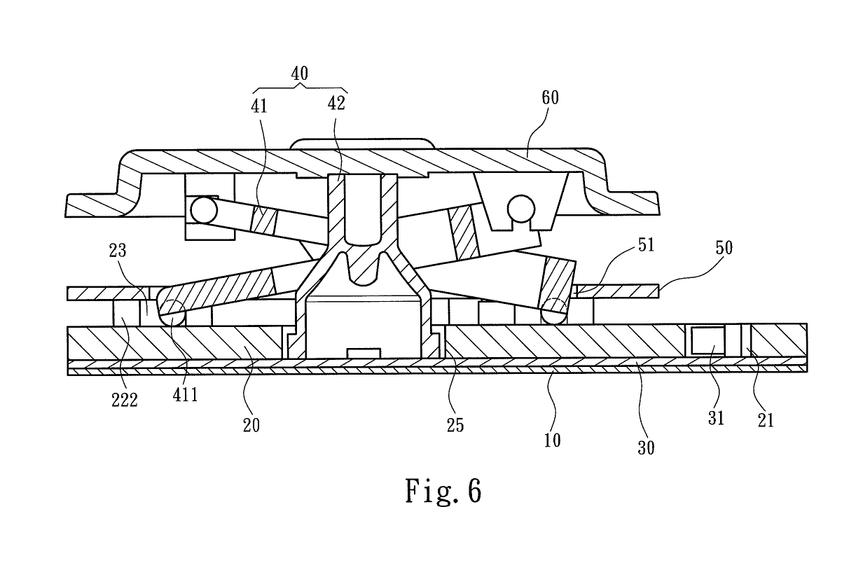

Referring to FIG. 5, in addition to the aforesaid embodiment, the light emitting element 31 may also be located at a lateral side of the keyboard portion so that light can enter the keyboard portion through the lateral side thereof, transmits between the shading plate 50 and bottom board 10, and passes through the opening 51 to project to the keycap 60. FIG. 6 illustrates yet another embodiment in which the circuit board 30 can be located between the baseboard 20 and bottom board 10, and the light emitting element 31 is located above the circuit board 30 and held in a holding cavity 21 of the baseboard 20. The baseboard 20 also has an aperture 25 to hold the elastic member 42 so that the light can sequentially pass through the circuit board 30 and aperture 25 of the baseboard 20, and project to the keycap 60.

As a conclusion, the invention mainly provides a keyboard portion including a baseboard 20 with a keycap 60 located thereon, and a light emitting portion with a shading plate 50 located below the keycap 60 and a light emitting element 31 to provide light. The shading plate 50 has an opening 51 corresponding to the keycap 60. Light emitted by the light emitting element 31 passes through the opening 51 and projects to the keycap 60. Therefore, the keyboard only illuminates light on the keycap 60 location while the gaps between the keycaps 60 do not emit light. Thus a non-uniform illumination is formed to highlight the location of the keycap 60, and keystroke accuracy is enhanced.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A backlight keyboard module, comprising:
a keyboard portion which includes a baseboard, a keycap movable up and down relative to the baseboard, and a circuit board depressed by the up and down movements of the keycap to output a signal; and
a light emitting portion including a shading plate located below the keycap and a light emitting element, the shading plate including an opening corresponding to the keycap so that light generated by the light emitting element passes through the opening and transmits to the keycap.

2. The backlight keyboard module of claim 1, wherein the circuit board is located between the baseboard and the keycap.

3. The backlight keyboard module of claim 2, wherein the light emitting element is located below the circuit board and the baseboard includes a holding cavity to hold the light emitting element.

4. The backlight keyboard module of claim 1, wherein the circuit board is located between the baseboard and the shading p late.

5. The backlight keyboard module of claim 4, wherein the light emitting element is located above the circuit board and the baseboard includes a holding cavity to hold the light emitting element.

6. The backlight keyboard module of claim 1, wherein the light emitting element is located at a lateral side of the keyboard portion.

7. The backlight keyboard module of claim 1, wherein the keyboard portion further includes a bottom board to hold the baseboard and the circuit board.

8. The backlight keyboard module of claim 1, wherein the baseboard includes an anchor portion to hold a driven mechanism connected with the keycap.

9. The backlight keyboard module of claim 8, wherein the driven mechanism includes a coupling member bridging the baseboard and the keycap, and an elastic member to support the keycap.

10. The backlight keyboard module of claim 9, wherein the anchor portion includes at least two horizontal detent portions to form a holding space therebetween, the coupling member including a retaining portion held in the holding space.

11. The backlight keyboard module of claim 10, wherein the shading plate includes a vertical detent portion to cover the holding space to confine the driven mechanism.

12. The backlight keyboard module of claim 10, wherein the anchor portion includes a detent wall to bridge the two horizontal detent portions to form a U shape therewith.

13. The backlight keyboard module of claim 12, wherein the detent wall is perpendicular to the two horizontal detent portions.
